(19) United States
(12) Patent Application Publication
(10) Pub. No.: US 2009/0294108 A1
(43) Pub. Date: Dec. 3, 2009

(54) Device for Filtering Airflow Into an Electrical Appliance

(76) Inventors: Gavin Paul Lee, Wellington (NZ); Brent Porter, Lower Hutt (NZ)

Correspondence Address: WOLF GREENFIELD & SACKS, P.C., 600 ATLANTIC AVENUE, BOSTON, MA, 02210-2206, US

(21) Appl. No.: 11/887,971

(22) PCT Filed: Apr. 5, 2006
(86) PCT No.: PCT/NZ2006/000066

§ 371 Date: Jan. 26, 2009

(30) Foreign Application Priority Data
Apr. 5, 2005 (NZ) 539220

(51) Int. Cl. F28D 21/00; B01D 46/02

(52) U.S. Cl. 165/120; 55/383; 95/273

(57) ABSTRACT

This invention relates to a device that can be used to filter airflow into an electrical appliance. The device comprises: (a) an air propulsion unit with an air outlet zone; and (b) a filtration unit, wherein the filtration unit is located downstream of the air outlet zone of the air propulsion unit. The surface area of the filtration unit may be equal to or greater than the surface area of the air outlet zone of the air propulsion unit. The invention also relates to an electrical appliance comprising such a device, a kit of parts, and a dust filtration element that is three-dimensional in shape.

This invention relates to a device, which in one embodiment can be used to filter airflow into an electrical appliance.

As used throughout the specification, the term “electrical appliance” is intended to refer to any device that uses electricity and requires internal cooling. The term “electrical appliance” includes but is not limited to: computer appliances, including a desktop computer, handheld computer, or laptop computer; home appliances, including a dishwasher, microwave oven, refrigerator, stereo system, television set, or video game console; and office appliances, including a facsimile machine, photocopier, printer, or projector.

### BACKGROUND TO THE INVENTION

Allowing air to enter an electrical appliance to cool the internal components is often necessary in order to prevent the appliance from overheating. However, unless the air entering the electrical appliance is filtered then dust can also enter the appliance. Dust is a conductor of electricity. Thus, the presence of dust inside an electrical appliance can cause overheating of electrical components, a short circuit or even a fire.

Air intake fans can increase the flow of air into an electrical appliance. However, the use of an air intake fan can also significantly increase the amount of dust drawn into the appliance.

In the prior art, for example U.S. Pat. No. 4,751,872 and U.S. Pat. No. 5,514,036, a flat dust filter is located upstream of an air intake fan so that the dust laden air is filtered before reaching the fan and passing into the electrical appliance.

The prior art has a number of difficulties and/or disadvantages associated with it, including:

(1) The location of the dust filter upstream of the air intake fan creates an air resistance that can reduce the airflow that can pass into the electrical appliance. The air resistance created by the dust filter increases as the filter becomes occluded with dust.
(2) The small surface area of the dust filter increases the air resistance of the filter and can further reduce the airflow that can pass into the electrical appliance.
(3) The small surface area of the dust filter can mean that the filter will become occluded with dust in a short period of time. The filter can therefore need to be frequently replaced, approximately once every month.

It is an object of the invention to provide a device that will overcome the abovementioned difficulties and/or disadvantages, or that will at least provide the public with a useful choice.

### SUMMARY OF THE INVENTION

According to a first aspect of the invention there is provided a device for filtering airflow into an electrical appliance said device comprising: (a) an air propulsion unit with an air outlet zone; and (b) a filtration unit, wherein the filtration unit is located downstream of the air outlet zone of the air propulsion unit.

Preferably the surface area of the filtration unit may be equal to or greater than the surface area of the air outlet zone of the air propulsion unit.

Preferably the filtration unit may comprise a three-dimensional filtration element that encloses a filter volume and has an opening sized to be received over the air outlet zone of the air propulsion unit. Preferably the filtration unit may also be geometric in shape, for example, the filtration unit may be in the shape of a cone, cube, cylinder, hemisphere, oval, polyhedron, prism, pyramid, sphere, or a part section thereof.

Preferably the filtration unit may be attached to the air outlet zone of the air propulsion unit by a means of attachment. Preferably the means of attachment may comprise an adhesive, bolt, buckle, button, cable, catch, chain, clamp, clasp, clip, dowel, elastic, hasp, hook, knot, latch, lock, nail, peg, pin, rivet, rope, screw, seal, solder, staple, stitch, strap, string, tack, tape, tie, toggle, or zip.

Preferably the air propulsion unit may comprise at least one fan.

Preferably the filtration unit may comprise a dust filtration element. The dust filtration element may be made from any suitable filter material, for example, a netted weave, fibre cotton, sponge, or any filtering material that is capable of removing dust particles while allowing sufficient air flow velocity.

According to a second aspect of the invention there is an electrical appliance comprising a device as described above.

Preferably the device may be installed in the appliance such that the upstream or inlet side of the device is in connection with an airflow from outside the appliance.

In one preferred embodiment the electrical appliance may be a computer appliance, including a desktop computer, handheld computer, or laptop computer.

In another preferred embodiment the electrical appliance may be a home appliance, including a dishwasher, microwave oven, refrigerator, stereo system, television set, or video game console.

In another preferred embodiment the electrical appliance may be an office appliance, including a facsimile machine, photocopier, printer, or projector

According to a third aspect of the invention there is a kit comprising: (a) an air propulsion unit with an air outlet zone; and (b) a filtration unit, wherein the filtration unit is arranged for connection to the downstream side of the air outlet zone of the air propulsion unit.

Preferably the surface area of the filtration unit may be equal to or greater than the surface area of the air outlet zone of the air propulsion unit.

Preferably the filtration unit may comprise a three-dimensional filtration element that encloses a filter volume and has an opening sized to be received over the air outlet zone of the air propulsion unit. Preferably the filtration unit may also be geometric in shape, for example, the filtration unit may be in the shape of a cone, cube, cylinder, hemisphere, oval, polyhedron, prism, pyramid, sphere, or a part section thereof.

Preferably the filtration unit may be arranged for connection to the downstream side of the air outlet zone of the air propulsion unit by a means of attachment. Preferably the means of attachment may comprise an adhesive, bolt, buckle, button, cable, catch, chain, clamp, clasp, clip, dowel, elastic, hasp, hook, knot, latch, lock, nail, peg, pin, rivet, rope, screw, seal, solder, staple, stitch, strap, string, tack, tape, tie, toggle, or zip.

Preferably the kit may comprise the means of attachment.

Preferably the air propulsion unit may comprise at least one fan.

Preferably the filtration unit may comprise a dust filtration element. The dust filtration element may be made from any suitable filter material, for example, a netted weave, fibre cotton, sponge, or any filtering material that is capable of removing dust particles while allowing sufficient air flow velocity.

According to a fourth aspect of the invention there is a dust filtration element that is three-dimensional in shape.

Preferably the dust filtration element may be geometric in shape, for example, the filtration element may be in the shape of a cone, cube, cylinder, hemisphere, oval, polyhedron, prism, pyramid, sphere, or a part section thereof.

Preferably the dust filtration element may be made from any suitable filter material, for example, a netted weave, fibre cotton, sponge, or any filtering material that is capable of removing dust particles while allowing sufficient air flow velocity.

### DETAILED DESCRIPTION OF THE INVENTION

A preferred embodiment of the device will now be described, by way of example only, with reference to the accompanying drawings in which:

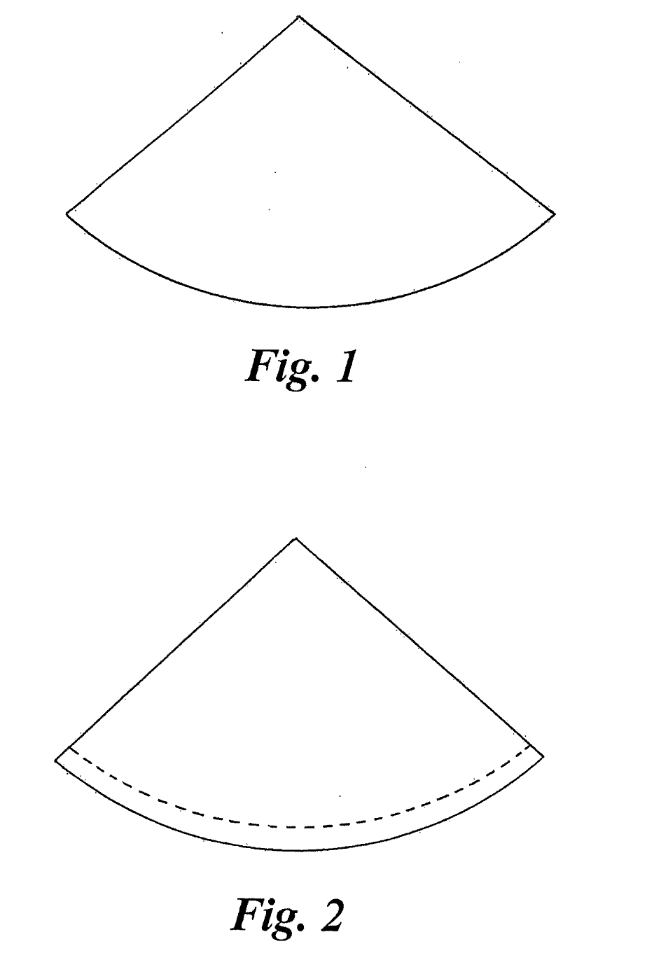

FIG. 1 is a plan view of a piece of cut filter material.

FIG. 2 is a plan view of a piece of cut filter material with a hem made along the arc.

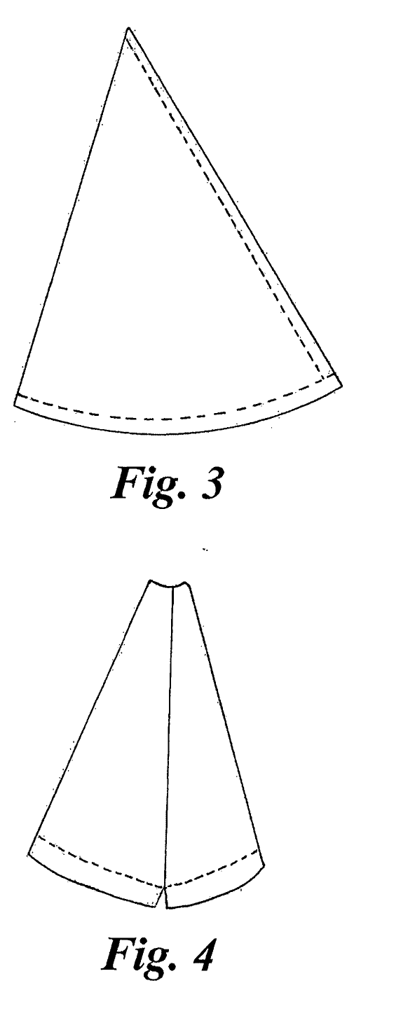

FIG. 3 is a plan view of a cone shaped filter with a hem made along the base and a seam made along the side.

FIG. 4 is a side view of a cone shaped filter.

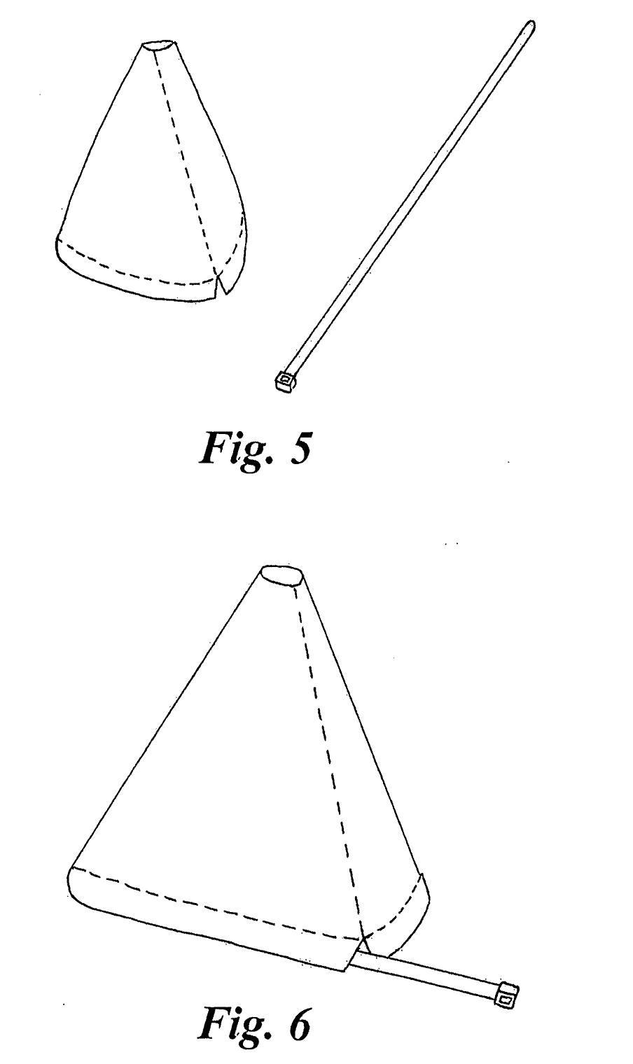

FIG. 5 is side view of a cone shaped filter and a cable tie.

FIG. 6 is a side view of a cone shaped filter with a cable tie partially inserted inside the hem.

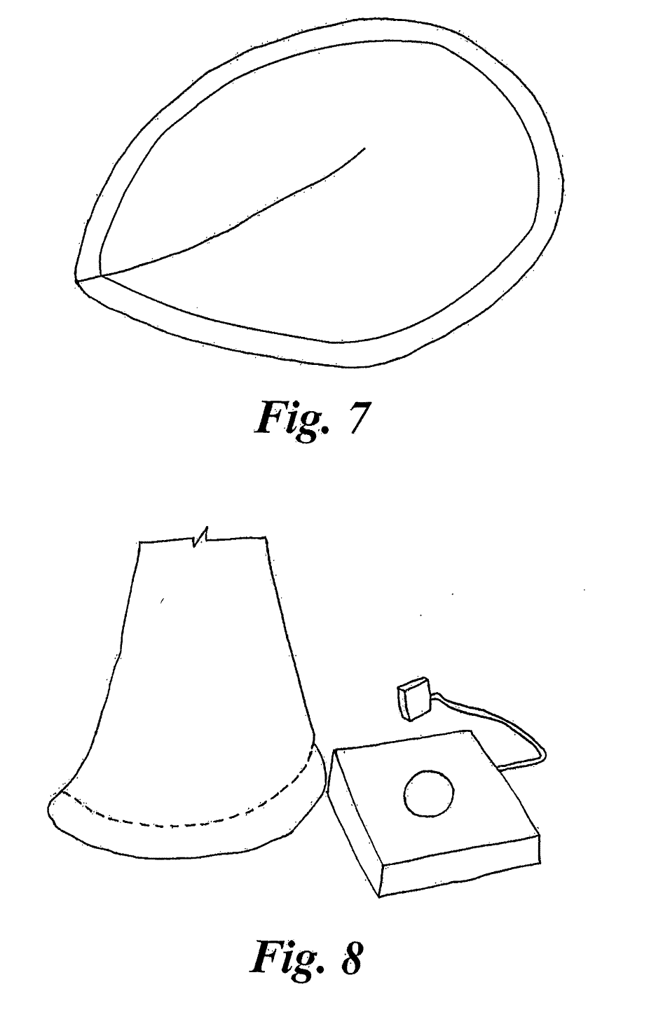

FIG. 7 is a rear view of a cone shaped filter.

FIG. 8 is a side view of a cone shaped filter and an air intake fan.

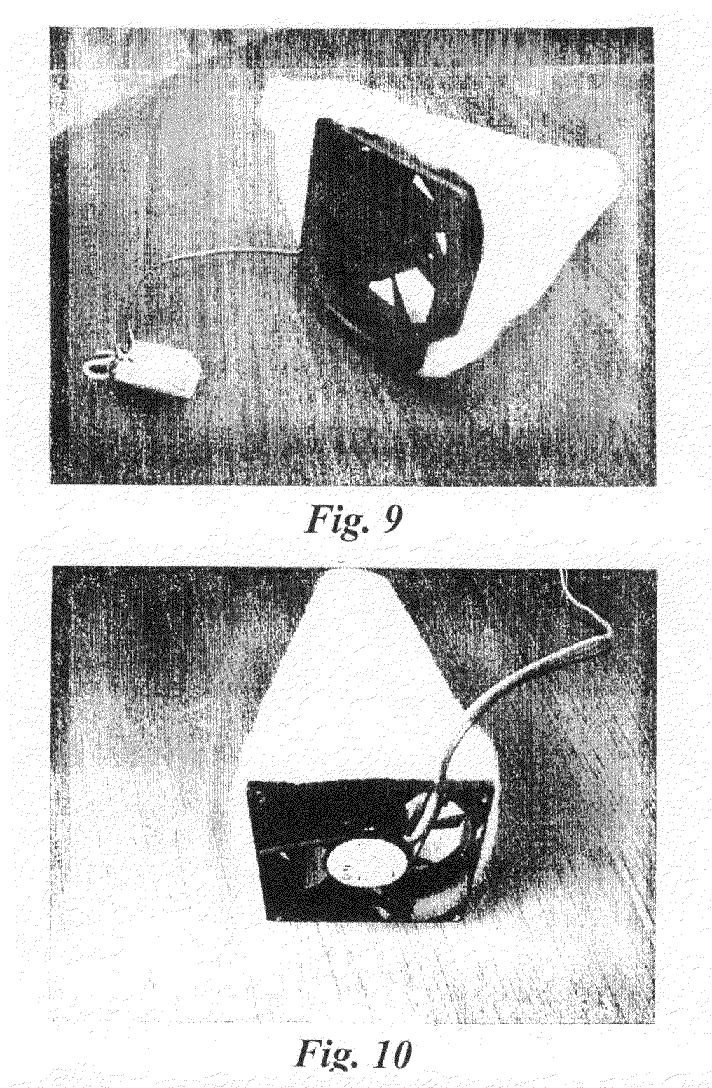

FIG. 9 is a perspective rear view of a cone shaped filter attached to an air intake fan.

FIG. 10 is a perspective rear view of a cone shaped filter attached to an air intake fan.

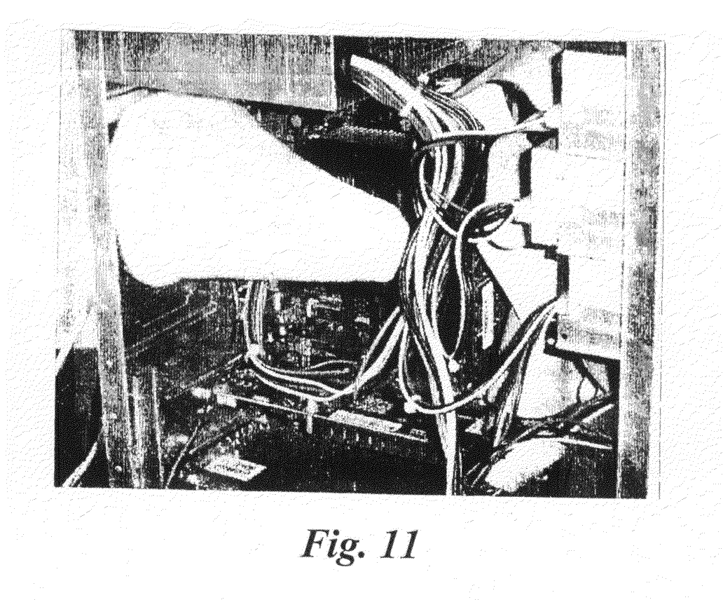

FIG. 11 is a perspective top view of a cone shaped filter attached to an air intake fan in a desktop computer.

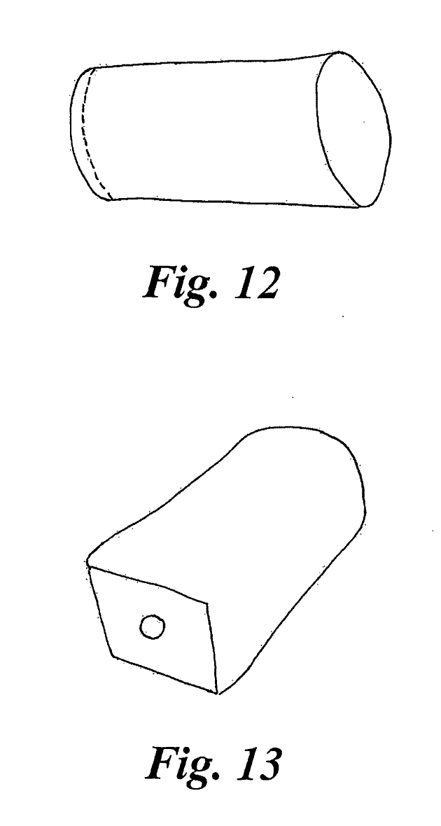

FIG. 12 is a perspective top view of a cylindrical filter.

FIG. 13 is a perspective rear view of a cylindrical filter attached to an air intake fan.

The device of the invention can be installed in any electrical appliance. In the preferred embodiment it is installed in a desktop computer.

The Central Processing Unit (CPU) of a desktop computer can generate a significant amount of heat, which often requires a cooling fan and a heat sink to maintain a working temperature. However, a cooling fan can draw dust laden air into the computer through vents and small openings around the case.

When dust accumulates on cooling fans and heat sinks, these components are not able to function at an optimal level and can lead to the CPU overheating and failing. When dust accumulates on the fan, this can inhibit the airflow around the heat sink and dust accumulating on a heat sink can trap heat.

Dust is also an electrical conductor that can cause short-circuiting on very fine and detailed circuit boards, such as, mother boards and circuit controllers.

Less air resistance is created by a filtration unit located downstream of the air outlet zone of an air propulsion unit than a filtration unit located upstream of the air outlet zone of an air propulsion unit. This means that an increased airflow can pass into the electrical appliance.

The air propulsion unit can be any suitable apparatus that propels air. In the preferred embodiment the air propulsion unit comprises at least one fan. The air propulsion unit can be powered by any suitable power source. The fan may be powered by an independent power supply, or, if suitable, may be powered from the mother board or other power supply in the computer or other appliance.

The filtration unit can be any suitable apparatus that filters air. In the preferred embodiment the filtration unit is a dust filtration element. The dust filtration element may be made from any suitable filter material, for example, a netted weave, fibre cotton, sponge, or any filtering material that is capable of removing dust particles while allowing sufficient air flow velocity.

The filtration material is cut, or otherwise shaped, to form a pattern depending on the intended size and shape of the dust filtration element. The dust filtration element can be of any size or shape depending upon the size and shape of the air outlet zone of the air propulsion unit to be covered by the filtration element and the available space in the electrical appliance into which the device is installed.

A three-dimensional dust filtration element increases the surface area of the element compared with a two-dimensional dust filtration element. The increased surface area of the dust filtration element can reduce the air resistance created by the element and can allow a greater airflow to pass through the element compared with a two-dimensional dust filtration element. The increased surface area of a three-dimensional dust filtration element can also mean that the element collects more dust than a two-dimensional dust filtration element and needs to be replaced less often, approximately once every year.

In the preferred embodiment the dust filtration element is cone shaped (FIG. 4). However, the dust filtration element can be of any shape, for example, cylindrical (FIG. 12). FIG. 1 shows a piece of filter material cut to make a cone shaped filtration element. Table 1 illustrates preferred dimensions of cone shaped and cylindrical dust filtration elements to fit an 80 mm and a 120 mm air intake fan.

TABLE 1
Preferred dimensions of cone shaped and cylindrical dust filtration elements.

| Filter type/fan size | Diameter | Length | Volume | Weight | Area |
|---|---|---|---|---|---|
| Cylindrical 80 mm | 10 cm | 20 cm | 1570 cm cubed | 15 g | 706 cm squared |
| Cone 80 mm | 10 cm | 20 cm | 523 cm cubed | 10 g | 314 cm squared |
| Cylindrical 120 mm | 14 cm | 20 cm | 3078 cm cubed | 15-20 g | 1032 cm squared |
| Cone 120 mm | 14 cm | 20 cm | 1035 cm cubed | 10 g | 418 cm squared |

The dust filtration element can be attached to a fan by any suitable means. In the preferred embodiment a hem is made along the arc of a piece of cut filter material (FIG. 2) and a seam is made along the side to secure the dust filtration element in its cone shape (FIG. 3). A cable tie is then inserted into the hem of the dust filtration element (FIGS. 5 and 6). The fan is placed inside the dust filtration element (FIG. 9) and the cable tie is fastened around the fan to secure the fan in place (FIG. 10).

The device can then be installed inside an electrical appliance, such as a desktop computer (FIG. 11). In the preferred embodiment the device is installed in the appliance to allow the cool air passing into the appliance to be heated by the internal components and to rise to the top of the appliance where the air can be expelled through an air exhaust fan.

The device can be removed without the need of a technician when the dust filtration element is occluded with dust, approximately, once every year. The dust filtration element or the entire device can then be disposed of and replaced, or alternatively, the dust filtration element or the entire device can be cleaned and reused.

While some preferred aspects of the invention have been described by way of example, it should be appreciated that modifications and/or improvements can occur without departing from the scope of the invention as set out in the claims.

The terms comprise, comprises, comprising, or comprised, if and when used herein, should be interpreted non-exclusively, that is, as conveying “consisting of or including”.

1.-44. (canceled)

45. An electrical appliance airflow filtration device, the device comprising:
(a) an air propulsion unit with an air outlet zone; and
(b) a three-dimensional filtration element located downstream of the air outlet zone of the air propulsion unit, the filtration element enclosing a filter volume with an opening sized to be received over the air outlet zone of the propulsion unit, wherein the filtration element is sized and shaped to fit inside an electrical appliance and the three-dimensional shape provides a multidirectional outflow of filtered air.

46. A device according to claim 45, wherein the filtration element is geometric in shape, including but not limited to, the shape of a cone, cube, cylinder, hemisphere, oval, polyhedron, prism, pyramid, sphere, or a part section thereof.

47. A device according to claim 45, wherein the filtration element is attached to the air outlet zone of the air propulsion unit by a means of attachment, including but not limited to, an adhesive, bolt, buckle, button, cable, catch, chain, clamp, clasp, clip, dowel, elastic, hasp, hook, knot, latch, lock, nail, peg, pin, rivet, rope, screw, seal, solder, staple, stitch, strap, string, tack, tape, tie, toggle, or zip.

48. A device according to claim 45, wherein the air propulsion unit comprises at least one fan.

49. A device according to claim 45, wherein the filtration element is a dust filtration element made out of any filtering material that is capable of removing dust particles while allowing sufficient airflow velocity, including but not limited to, a netted weave, fibre cotton, or sponge.

50. An electrical appliance containing a device according to claim 45, wherein the device is installed in the appliance such that the upstream side of the device is in connection with the airflow outside the appliance.

51. An electrical appliance according to claim 50, wherein the appliance is one of the following: (a) a computer appliance, including but not limited to, a desktop computer, handheld computer, or laptop computer; (b) a home appliance, including but not limited to, a dishwasher, microwave oven, refrigerator, stereo system, television set, or video game console; or (c) an office appliance, including but not limited to, a facsimile machine, photocopier, printer, or projector.

52. A kit comprising:
(a) an air propulsion unit with an air outlet zone; and
(b) a three-dimensional filtration element arranged for connection to the downstream side of the air outlet zone of the air propulsion unit, the filtration element enclosing a filter volume with an opening sized to be received over the air outlet zone of the propulsion unit, wherein the filtration element is sized and shaped to fit inside an electrical appliance and the three-dimensional shape provides a multidirectional outflow of filtered air.

53. A kit according to claim 52, wherein the filtration element is geometric in shape, including but not limited to, the shape of a cone, cube, cylinder, hemisphere, oval, polyhedron, prism, pyramid, sphere, or a part section thereof.

54. A kit according to claim 52, wherein the filtration element is arranged for connection to the downstream side of the air outlet zone of the air propulsion unit by a means of attachment, including but not limited to, an adhesive, bolt, buckle, button, cable, catch, chain, clamp, clasp, clip, dowel, elastic, hasp, hook, knot, latch, lock, nail, peg, pin, rivet, rope, screw, seal, solder, staple, stitch, strap, string, tack, tape, tie, toggle, or zip.

55. A kit according to claim 52, wherein the air propulsion unit comprises at least one fan.

56. A kit according to claim 52, wherein the filtration element is a dust filtration element made out of any filtering material that is capable of removing dust particles while allowing sufficient airflow velocity, including but not limited to, a netted weave, fibre cotton, or sponge.

57. A kit according to claim 52, wherein the electrical appliance is one of the following:
(a) a computer appliance, including but not limited to, a desktop computer, handheld computer, or laptop computer; (b) a home appliance, including but not limited to, a dishwasher, microwave oven, refrigerator, stereo system, television set, or video game console; or (c) an office appliance, including but not limited to, a facsimile machine, photocopier, printer, or projector.

58. The use of a device for filtering airflow into an electrical appliance, the device comprising:
(a) an air propulsion unit with an air outlet zone; and
(b) a three-dimensional filtration element located downstream of the air outlet zone of the air propulsion unit, the filtration element enclosing a filter volume with an opening sized to be received over the air outlet zone of the propulsion unit, wherein the filtration element is sized and shaped to fit inside an electrical appliance and the three-dimensional shape provides a multidirectional outflow of filtered air.

59. A use according to claim 58, wherein the filtration element is geometric in shape, including but not limited to, the shape of a cone, cube, cylinder, hemisphere, oval, polyhedron, prism, pyramid, sphere, or a part section thereof.

60. A use according to claim 58, wherein the filtration element is attached to the air outlet zone of the air propulsion unit by a means of attachment, including but not limited to, an adhesive, bolt, buckle, button, cable, catch, chain, clamp, clasp, clip, dowel, elastic, hasp, hook, knot, latch, lock, nail, peg, pin, rivet, rope, screw, seal, solder, staple, stitch, strap, string, tack, tape, tie, toggle, or zip.

61. A use according to claim 58, wherein the air propulsion unit comprises at least one fan.

62. A use according to claim 58, wherein the filtration element is a dust filtration element made out of any filtering material that is capable of removing dust particles while allowing sufficient airflow velocity, including but not limited to, a netted weave, fibre cotton, or sponge.

63. A use according to claim 58, wherein the electrical appliance is one of the following:
(a) a computer appliance, including but not limited to, a desktop computer, handheld computer, or laptop computer; (b) a home appliance, including but not limited to, a dishwasher, microwave oven, refrigerator, stereo system, television set, or video game console; or (c) an office appliance, including but not limited to, a facsimile machine, photocopier, printer, or projector.

64. A method of cooling the interior of an electrical appliance comprising the use of a device according to claim 45 to direct filtered air into the appliance.
